(19) United States
(12) Patent Application Publication
(10) Pub. No.: US 2025/0121836 A1
(43) Pub. Date: Apr. 17, 2025

(54) SYSTEM FOR VEHICLE FAULT DETECTION, AND VEHICLE EMPLOYING SYSTEM

(71) Applicants: Futaijing Precision Electronics (Yantai) Co., Ltd., Yantai (CN); HON HAI PRECISION INDUSTRY CO., LTD., New Taipei (TW)

(72) Inventors: PO-HSUN SER, New Taipei (TW); KO-CHI HUANG, New Taipei (TW); BING-EN CHIH, New Taipei (TW)

(21) Appl. No.: 18/749,659

(22) Filed: Jun. 21, 2024

(30) Foreign Application Priority Data
Oct. 17, 2023 (CN) 202322784595.1

(51) Int. Cl. B60W 50/02; B60W 50/14; H04L 12/42

(52) U.S. Cl. CPC B60W 50/0205; B60W 50/14; H04L 12/42; B60W 2050/021; B60W 2050/143; B60W 2050/146; H04L 2012/421

(57) ABSTRACT

A vehicle fault detection system comprises a master controller, a fault display, and a plurality of sub-controllers. The fault display and the plurality of sub-controllers are communicated with the master controller respectively. The vehicle comprises a plurality of zones. The plurality of sub-controllers are configured to collect operating status information of components in the plurality of zones of the vehicle respectively, and preprocess the operating status information to remove interference information to operating status information set to be processed, and send the operating status information set to the master controller. One of the plurality of sub-controllers corresponds to at least one of the plurality of zones. The master controller is configured to detect faults of the operating state information set and generate fault detection information. The fault display is configured to detect and classify the fault detection information and generate a fault detection result. A vehicle is also provided.

### TECHNICAL FIELD

The subject matter herein generally relates to vehicle fault detections.

### BACKGROUND

In the process of driving, due to extended use and nature environment, such as weather, various parts of the vehicle may be impacted and resulting in different driving failures.

A vehicle is a complex mechanical system made up of thousands of components. If the user can accurately determine the causes of failures of the vehicle according to some abnormal phenomena of the vehicle, the reliability, economy, and safety of the use of the vehicle can be improved, and the cost of blind maintenance can be reduced. However, to discovery vehicle faults, the user is required to have high professional and technical knowledge of the vehicles. Even so, sometimes the vehicle faults can not be found in time, resulting in missing the best maintenance period, and large maintenance cost, which may even cause accidents.

### BRIEF DESCRIPTION OF THE DRAWINGS

Implementations of the present technology will now be described, by way of example only, with reference to the attached figures.

FIG. 1 is a structure diagram of a vehicle fault detection system in one embodiment of the present application.

FIG. 2 is a structure diagram of the vehicle fault detection system in another embodiment of the present application.

FIG. 3 is a structure diagram of the vehicle fault detection system in another embodiment of the present application.

FIG. 4 is a structure diagram of the vehicle fault detection system in another embodiment of the present application.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, vehicle fault detection systems, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure. It should be noted that references to “an” or “one” embodiment in this disclosure are not necessarily to the same embodiment, and such references mean “at least one”.

Several definitions that apply throughout this disclosure will now be presented.

The term “coupled” is defined as connected, whether directly or indirectly through intervening components, and is not necessarily limited to physical connections. The connection can be such that the targets are permanently connected or releasably connected. The term “comprising,” when utilized, means “including, but not necessarily limited to”; it specifically indicates open-ended inclusion or membership in the so-described combination, group, series, and the like.

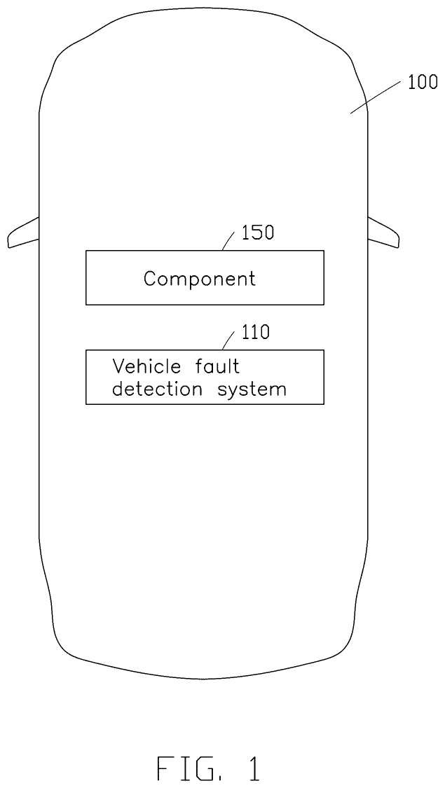

FIG. 1 is a structure diagram of a vehicle fault detection system 110 in one embodiment of the present application. The vehicle fault detection system 110 can be set in a vehicle 100. The vehicle 100 includes a vehicle fault detection system 110 and vehicle components 150. The vehicle fault detection system 110 collects the operation of the vehicle components 150, and conducts fault detection analysis and fault warning for the overall operation of vehicle 100. The vehicle 100 can be intelligent vehicles, traditional vehicles, new energy vehicles, commercial vehicles, engineering vehicles, etc. Among them, the traditional vehicles include diesel vehicles, gasoline vehicles, etc., the new energy vehicles include pure electric vehicles, hybrid vehicles, etc., and the engineering vehicles include trailers, forklifts, etc. The type of vehicle 100 is not limited in this application. The vehicle components 150 can be engines, generators, motors, doors, windows, air conditioners, accelerators, wipers, etc.

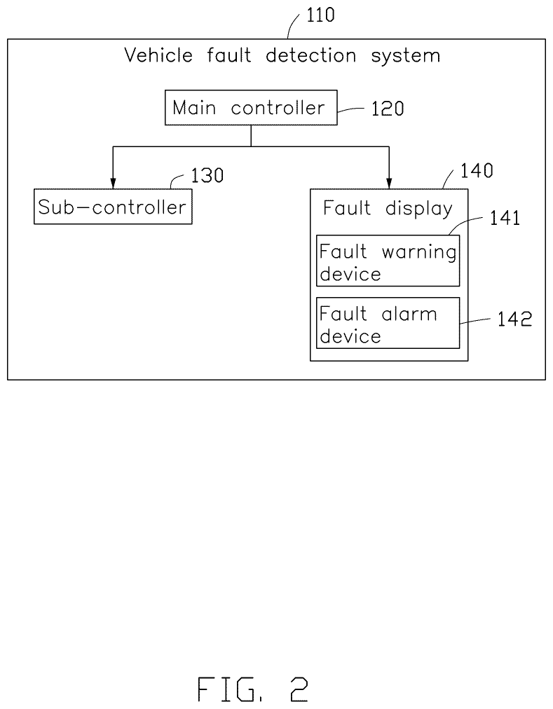

Referring to FIG. 2, the vehicle fault detection system 110 includes a master controller 120, a fault display 140, and a plurality of sub-controllers 130. The fault display 140 and the plurality of sub-controllers 130 are communicated with the master controller 120 respectively. The vehicle 100 includes a plurality of zones. The plurality of sub-controllers 130 are configured to collect the operating status information of components 150 in the plurality of zones of the vehicle respectively, and preprocess the operating status information to remove interference information, obtaining operating status information set to be processed, and send the operating status information set to the master controller 120. One of the plurality of sub-controllers 130 corresponds to at least one of the plurality of zones. The master controller 120 is configured to detect faults of the operating state information set and generate fault detection information. The fault display 140 is configured to detect and classify the fault detection information and generate the fault detection result.

In one embodiment, the vehicle 100 can be divided into two or more zones according to the structure of the vehicle 100. For example, the vehicle 100 can be divided into chassis zone and body zone, or the vehicle 100 can be divided into two zones in the direction parallel to the body, two zones in the direction perpendicular to vehicle body or around the vehicle body, and the vehicle body is equally divided into four zones, etc. This application does not limit the zone division of the vehicle 100, as long as it ensures that a sub-controller 130 corresponds to at least one zone.

In one embodiment, each sub-controller 130 collects and preprocesses operating status information of the plurality of zones of the vehicle 100. For example, the status information can be classified according to main data sources of the operation of the vehicle 100. The main data can be divided into noise data, heat data, and air flow data, that is, the plurality of sub-controllers 130 can divide the collected operating status information of the components 150 in the corresponding zone according to the three data categories of noise data, heat data, and air flow data, and get overall component 150 operating status information of the vehicle 100.

For example, a sub-controller 130 collects the operating status information of engine components 150 in a certain zone. The sub-controller 130 divides the operating status information of engine components according to the three data categories of noise data, heat data and air flow data, and obtains the operating status information of components under the condition of engine operation: engine-noise data, engine-heat data, and engine-air flow data. It is understood that for other components 150 of the vehicle 100, the sub-controller 130 can also obtain the corresponding component operating status information of other zones, so that the overall component operating status information of vehicle 100 can be obtained.

It should be understood that the sub-controller 130 can actively collect the operating status information of the components 150 in the corresponding zone in real time or periodically, or the master controller 120 can control the sub-controller 130 to collect the operating status of the components 150 in the corresponding zone. This application does not restrict the way of sub-controller 130 to collect the operating status information of the components 150 in the corresponding zone, and the vehicle fault detection system 110 can be selected according to the actual situation. The periodic value can be set based on the actual situation, for example, every 1 minute or every 30 seconds.

In one embodiment, after removing the interference information from the component operating status information in the corresponding zone, the sub-controller 130 obtains the operating status information set to be processed and sends the operating status information set to the master controller 130. For example, when the sub-controller 130 divides the component operating status information according to three kinds of data (noise data, heat data and air flow data), bases on the preset noise interval, preset heat interval, and preset air flow interval. The sub-controller 130 can delete the data within the preset noise interval, preset heat interval, and preset air flow interval, which is the normal operating state of the component. The operating state information of the component outside the preset noise interval, preset heat interval, and preset air flow interval, which is abnormal operating state of the component, can be regarded as the operating state information set to be processed. Among them, the preset noise interval, preset heat interval, and preset air flow interval respectively refer to the noise data interval, heat data interval, and air flow data interval generated during the normal operation of the vehicle 100. By this way, the operating status information set sent to the master controller 120 only includes the abnormal component operating status information, reducing the data that needs to be detected when the master controller 120 detects the engine operating status according to the operating status information set, and improving the efficiency of fault detection.

In one embodiment, the master controller 120 can process the operating state information set for fault detection and generate fault detection information. For example, the master controller 120 can detect faults based on a preset fault diagnosis model for processing the operational state information set.

In one embodiment, the preset fault diagnosis model can be trained by the following ways: according to the historical operating conditions of vehicle 100, the historical operating state information of the components 150 of vehicle 100 is collected for fault diagnosis training, and the preset fault diagnosis model is obtained. The historical health information can be a default value, a default range, or a code. The training methods of the preset fault diagnosis model are not limited in this application, and the preset fault diagnosis model can be obtained by selecting different training methods according to the actual needs.

In one embodiment, in order to ensure the accuracy and timeliness of fault detection, the preset fault diagnosis model can be set aimed at noise data, heat data, and air flow data respectively. The fault detection information can be a value or a data range.

In one embodiment, the preset fault diagnosis model includes a first preset fault diagnosis model corresponding to noise data, a second preset fault diagnosis model corresponding to heat data, and a third preset fault diagnosis model corresponding to airflow data. The historical operating status information includes the overall historical operating status information of vehicle 100. The overall historical operating status information of vehicle 100 includes the noise data, heat data, and air flow data of all components 150 of vehicle 100. The first preset fault diagnosis model, the second preset fault diagnosis model, and the third preset fault diagnosis model can be obtained by fault diagnosis training according to the corresponding noise data, heat data, and air flow data of each component. In practical application, for the received operating state information set, the master controller 120 can divide the operating state information set according to three data types: noise data, heat data, and air flow data, and inputs the noise data, the heat data, and the air flow data into the first preset fault diagnosis model, the second preset fault diagnosis model, and the third preset fault diagnosis model respectively. Thus more accurate fault diagnosis results can be obtained.

In one embodiment, the fault display 140 can detect and classify fault detection information and generate fault detection results. The fault display 140 includes a fault warning device 141 and a fault alarm device 142. The fault warning device 141 and the fault alarm device 142 are respectively communicated with the master controller 120. The master controller 120 sends the fault detection result to the fault alarm 142. The vehicle fault detection system 110 can classify the types of faults into serious faults, ordinary faults, and minor faults. Among them, serious faults means that the owner needs to stop the vehicle immediately and repair the vehicle 100, general failure means that the owner can then repair the vehicle 100, minor failure means that the owner can repair the vehicle 100 in spare time. This application does not limit the fault types, and the fault types can be classified according to the actual situation.

In one embodiment, the master controller 120 can also perform component health detection according to operating status information, generating component health status results, and send the component health status results to the fault alarm device 141. For example, the master controller 120 can detect and analyze the component health based on the operating status information, obtaining the component health value, and display and remind the component health status based on the component health value. For example, a component health standard table can be set, to identify a component with a health value of more than 90 points as being in perfect working condition, a component with a health value of more than 60 points and less than 90 points as being in normal working condition, a component with a health value of more than 30 points and less than 60 points as being in poor working condition, and a component with a health value of less than 30 points as being in poor operating condition. According to the health data of the components 150 and the health standard of the components 150, the identification of the components 150 can be obtained, which can provide the basis for the maintenance.

In one embodiment, the master controller 120 includes a plurality of first main control communication interfaces Z1. Each sub-controller 130 includes a first sub-control communication interface H1, and each first main control communication interface Z1 is configured to communicates with one sub-control communication interface H1. Each sub-controller 130 of at least two sub-controllers 130 includes a second sub-control communication interface H2, and the at least two sub-controllers 130 communicate with each other through the second sub-control communication interface H2. A ring communication link is formed between the plurality of sub- controllers 130 through the second sub-control communication interface H2. The ring communication link includes a plurality of nodes, and each sub-controller 130 in the plurality of sub-controllers 130 forms one of the plurality of nodes. A chain communication link is formed between multiple sub-controllers 130 through the second sub-control communication interface H2. The ring communication link includes a plurality of nodes, and each sub-controller 130 in the plurality of sub-controllers 130 forms one of the plurality of nodes. Therefore, the vehicle fault detection system 110 can form communication redundancy between the master controller 120 of vehicle 100 and the at least two sub-controllers 130, so that when a communication fault occurs in the communication network of any layer, the communication between the master controller 120 and the at least two sub-controllers 130 can be realized through another layer of communication network. Thus improving the overall communication efficiency of the vehicle. In addition, the present application embodiments do not limit the location of each of the plurality of sub-controllers 130, only need to ensure that at least two layers of communication network are formed between at least two sub-controllers 130.

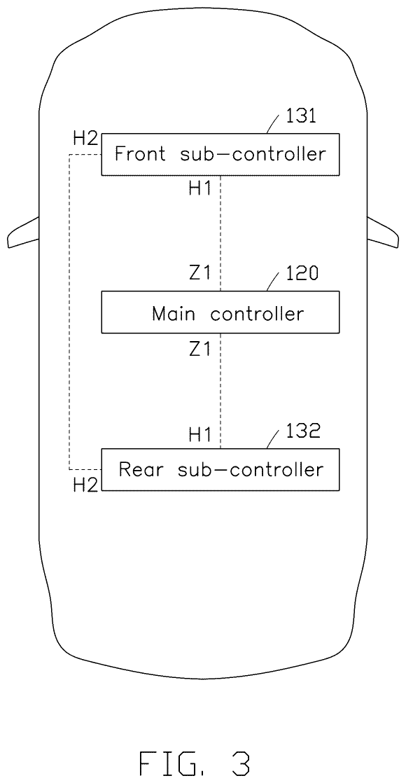

Referring to FIG. 2 and FIG. 3, the vehicle 100 is equally divided into two zones along the direction parallel to the vehicle body: the front-zone and the rear-zone. The front-zone includes a front sub-controller 131. The rear-zone includes a rear sub-controller 132. For example, the front sub-controller 131 can collect the operating status information of the components 150 located in the front-zone of the vehicle 100, including the operating frequency of the wiper, the noise data of the engine, the resistance data of the brake, etc. The rear sub-controller 132 can collect information about the operation status of components 150 located in the rear-zone of the vehicle 100, for example, pressure data on the rear door handles, the opening and closing of the door, etc. Each sub-controller 130 can preprocess the collected component operating status information, obtaining the pending operating status information set after removing interference information, and sends the operating status information set to the master controller 120 for fault detection.

In one embodiment, the master controller 120 can receive the operating status information of the components 150 in the front-zone and the rear-zone, and perform fault detection based on the operating status information of the components 150 in the two zones. For one example, the master controller 120 can judge the operation of the wiper according to the received information such as the working frequency of the wiper, and determine whether the wiper will fail or has failed. For another example, the master controller 120 can conduct fault detection analysis according to the noise data of the engine. When the noise data of the engine is not within the normal noise data range, the engine may fail. Then, the fault display 140 can detect and classify the fault detection information received from the master controller 120, and warn the owner based on the fault detection result.

In one embodiment, the master controller 120 includes two first main control communication interfaces Z1. The front sub-controller 131 and the rear sub-controller 132 both include the first sub-control communication interface H1 and the second sub-control communication interface H2, and the front sub-controller 131 communicates with the rear sub-controller 132 through the second sub-control communication interface H2. The front sub-controller 131 and rear sub-controller 132 communicate with primary controller 120 through the first sub-control communication interface H1 and the first main control communication interface Z1. For example, when the first sub-control communication interface H1 or the first main control communication interface Z1 between the master controller 120 and the front sub-controller 131 fails, the master controller 120 can communicate with the rear sub- controller 132 through the first sub-control communication interface H1 and the first primary control communication interface Z1. The rear sub-controller 132 can communicate with the front sub-controller 131 through the second sub-control communication interface H2. In this way, the master controller 120 can communicate with the front sub-controller 131, avoiding communication failure between the sub-controller 130 and the master controller 120 due to the failure of a communication interface.

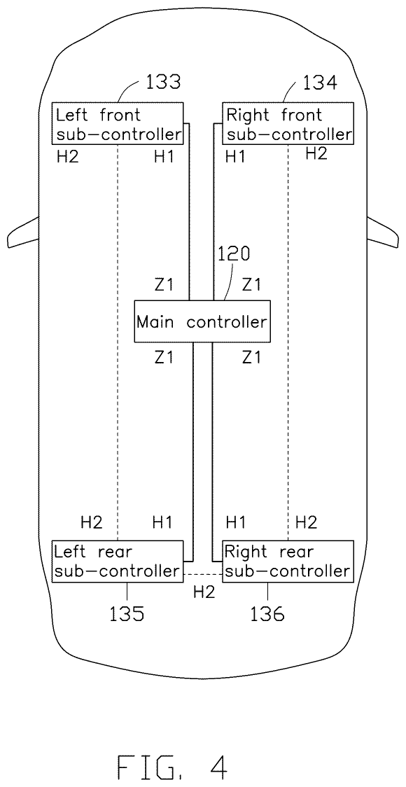

Referring to FIG. 2 and FIG. 4, in one embodiment, the vehicle 100 is equally divided into four zones along the parallel and vertical directions of the body: left front-zone, left rear-zone, right front-zone and right rear-zone. Each zone can be provided with a sub-controller 130, named as left front sub-controller 133, right front sub-controller 134, left rear sub-controller 135 and right rear sub-controller 136. The left front sub-controller 133 can collect the operating status information of the components 150 located in the left front-zone of the vehicle 100. For example, The left front sub-controller 133 can collect the operating frequency of the windshield wiper and brake resistance data in the left front-zone. The right rear sub-controller 136 can collect information about the operation status of the components 150 located in the right rear-zone of the vehicle 100. For example, the pressure data of the door handle in the right rear-zone, the opening and closing of the door, etc. Each sub-controller 130 can preprocess the collected component operating status information, obtaining the pending operating status information set after removing interference information, and send the operating status information set to the master controller 120 for fault detection.

In one embodiment, the master controller 120 can receive the operating status information of components 150 in four zones, including left-front-zone, left-rear-zone, right-front-zone and right-rear-zone, and perform fault detection based on the operating status information of components 150 in four zones. For one example, the master controller 120 can judge the operation of the wiper according to the received information such as the working frequency of the wiper, and determine whether the wiper will fail or has failed. For another example, the master controller 120 can conduct fault detection and analysis according to the noise data of the engine. When the noise data of the engine is not within the normal noise data range, the engine may fail. Then, the fault display 140 can detect and classify the fault detection information received from the master controller 120, obtaining the fault detection result after fault classification. The fault display 140 can further warn the owner based on the fault detection result.

In one embodiment, The master controller 120 includes four first main control communication interfaces Z1. The left front sub-controller 133, the right front sub-controller 134, the left rear sub-controller 135, and the right rear sub-controller 136 all include the first sub-control communication interface H1 and the second sub-control communication interface H2. The left front sub-controller 133, right front sub-controller 134, left rear sub-controller 135, and right rear sub-controller 136 can communicate with each other in the form of a ring communication link or a chain communication link through the second sub-control communication interface H2. The left front sub-controller 133, the right front sub-controller 134, the left rear sub-controller 135, and the right rear sub-controller 136 communicate with the master controller 120 through the first sub-control communication interface H1 and the first main control communication interface Z1. For example, when the first sub-control communication interface H1 or the first primary control communication interface Z1 between the primary controller 120 and the left front-sub-controller 133 fails, through the first sub-control communication interface H1 or the first main control communication interface Z1, the master controller 120 can communicate with other sub-controllers 130 except the left front sub-controller 133, and finally communicate with the left front sub-controller 133. Avoiding the communication failure between the sub-controller 130 and the master controller 120 caused by the failure of a communication interface.

In one embodiment, two or three sub-controllers 130 can also be set in the vehicle fault detection system. When two sub-controllers 130 are be set, one sub-controller 130 can be configured to collect the operating status information of the components 150 in the left front-zone and left rear-zone, and the other sub-controller 130 can be configured to collect the operating status information of the components 150 in the right front-zone and right back-zone. Alternatively, a sub-controller 130 can be configured to collect the operating status information of components 150 in the left-front-region and right-front-region, and the other sub-controller 130 can be sub-controller 130 collect the operating status information of components 150 in the left-rear-region and right-back-region. When three sub-controllers 130 are be set, one sub-controller 130 can be responsible for collecting the operating status information of the components 150 in the right front-zone and the right rear-zone, one sub-controller 130 can be configured to collect the operating status information of the components 150 in the left front-zone, and another sub-controller 130 can be configured to collect the operating status information of the components 150 in the left rear-zone. This application does not limit the vehicle zone corresponding to the sub-controller, as long as each sub-controller corresponds to one or more zones.

The vehicle fault detection system 110, as shown in FIG. 1 to FIG. 4, firstly can divide the vehicle body into a plurality of zones according to the actual requirements, and the plurality of sub-controllers 130 can be arranged on the vehicle body so that each sub-controller 130 can correspond to at least one zone. The control relationship between the sub-controller 130 and the zone can be set according to the actual fault detection requirements to improve the efficiency of data acquisition. Then, each sub-controller 130 can collect the operating status information of components 150 in one or more corresponding zones, and preprocess the collected operating status information, transmitting the pre-processed operating status information set to the master controller 120 for fault detection. The preprocessing of component operating state information can improve the efficiency of fault detection of the master controller 120. Then, the master controller 120 can analyze and detect the operating status information set to obtain the fault detection information. Finally, the fault detection information can be classified and the fault tips are given to improve the safety during driving. Thus, the problems such as high maintenance cost and accidents caused by the failure of parts, which can not be found in time, can be avoid.

The exemplary embodiments shown and described above are only examples. Many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims. It will therefore be appreciated that the exemplary embodiments described above may be modified within the scope of the claims.

What is claimed is:

1. A vehicle fault detection system applied in a vehicle, comprising a master controller, a fault display, and a plurality of sub-controllers,
wherein the fault display and the plurality of sub-controllers are communicated with the master controller respectively, the vehicle comprises a plurality of zones;
the plurality of sub-controllers is configured to collect operating status information of components in the plurality of zones of the vehicle respectively, and preprocess the operating status information to remove interference information to obtain operating status information set, and send the operating status information set to the master controller, one of the plurality of sub- controllers corresponds to at least one of the plurality of zones;
the master controller is configured to detect faults of the operating state information set and generate fault detection information;
the fault display is configured to detect and classify the fault detection information and generate a fault detection result.

2. The vehicle fault detection system of claim 1, wherein the fault display comprises a fault warning device and a fault alarm device, the fault warning device and the fault alarm device are respectively communicated with the master controller, the master controller sends the fault detection result to the fault alarm device, the master controller is further configured to perform a component health detection on the operating status information, generate a component health status result, and send the component health status result to the fault warning device.

3. The vehicle fault detection system of claim 1, wherein the master controller comprises a plurality of first main control communication interfaces, each of the plurality of sub-controllers comprises a first sub-control communication interface, each of the plurality of first main controls communication interface is configured to communicates with a corresponding one of the plurality of sub-control communication interfaces.

4. The vehicle fault detection system of claim 3, wherein each of at least two sub-controllers of the plurality of sub-controllers comprises a second sub-control communication interface, the at least two sub-controllers communicate with each other through the second sub-control communication interfaces.

5. The vehicle fault detection system of claim 4, wherein a ring communication link is formed among the plurality of sub-controllers through the second sub-control communication interfaces, the ring communication link comprises a plurality of nodes, each of the plurality of sub-controllers forms one of the plurality of nodes.

6. The vehicle fault detection system of claim 4, wherein a chain communication link is formed among the plurality of sub-controllers through the second sub-control communication interfaces, the chain communication link comprises a plurality of nodes, each of the plurality of sub-controllers forms one of the plurality of nodes.

7. A vehicle comprising a vehicle fault detection system, wherein the vehicle fault detection system comprises a master controller, a fault display, and a plurality of sub-controllers;
the fault display and the plurality of sub-controllers are communicated with the master controller respectively, the vehicle comprises a plurality of zones;
the plurality of sub-controllers is configured to collect operating status information of components in the plurality of zones of the vehicle respectively, and preprocess the operating status information to remove interference information to obtain operating status information set, and send the operating status information set to the master controller, one of the plurality of sub- controllers corresponds to at least one of the plurality of zones;
the master controller is configured to detect faults of the operating state information set and generate fault detection information;
the fault display is configured to detect and classify the fault detection information and generate a fault detection result.

8. The vehicle of claim 7, wherein the fault display comprises a fault warning device and a fault alarm device, the fault warning device and the fault alarm device are respectively communicated with the master controller, the master controller sends the fault detection result to the fault alarm device, the master controller is further configured to perform a component health detection on the operating status information, generate a component health status result, and send the component health status result to the fault warning device.

9. The vehicle of claim 7, wherein the master controller comprises a plurality of first main control communication interfaces, each of the plurality of sub-controllers comprises a first sub-control communication interface, each of the plurality of first main controls communication interface is configured to communicates with a corresponding one of the plurality of sub-control communication interfaces.

10. The vehicle of claim 9, wherein each of at least two sub-controllers of the plurality of sub-controllers comprises a second sub-control communication interface, the at least two sub-controllers communicate with each other through the second sub-control communication interfaces.

11. The vehicle of claim 10, wherein a ring communication link is formed among the plurality of sub-controllers through the second sub-control communication interfaces, the ring communication link comprises a plurality of nodes, each of the plurality of sub-controllers forms one of the plurality of nodes.

12. The vehicle of claim 10, wherein a chain communication link is formed among the plurality of sub-controllers through the second sub-control communication interfaces, the chain communication link comprises a plurality of nodes, each of the plurality of sub-controllers forms one of the plurality of nodes.
